(19) United States
(12) Patent Application Publication
(10) Pub. No.: US 2006/0032435 A1
(43) Pub. Date: Feb. 16, 2006

(54) Apparatus for treating a particulate material and method for operating the apparatus

(76) Inventors: Herbert Huettlin, Lorrach (DE); Wolfgang Huettlin, Kandern (DE); Kai Koch, Steinen-Hollstein (DE); Christian Toschka, Steinen (DE)

Correspondence Address: HARNESS, DICKEY & PIERCE, P.L.C., P.O. BOX 828, BLOOMFIELD HILLS, MI, 48303, US

(21) Appl. No.: 11/201,080

(22) Filed: Aug. 10, 2005

Related U.S. Application Data
(63) Continuation of application No. PCT/EP04/01256, filed on Feb. 11, 2004.

(30) Foreign Application Priority Data
Feb. 12, 2003 (DE) 103 06 684.5

(51) Int. Cl. B05C 13/02; B01F 9/00; B05C 3/00

(52) U.S. Cl. 118/52; 118/417; 118/418; 366/225; 366/228

(57) ABSTRACT

An apparatus for treating a particulate material comprising a container, which has a base, an upright wall, extending from bottom to top, and, in an upper region, a deflecting element, to deflect the material rising up along the wall in its direction of movement in such a way that it can return again to the base, it being possible for at least the wall to be driven in rotation about a vertical axis of rotation. In the upper region of the container there is at least one container element which can be driven in rotation in the same direction as the upright wall, but with lower rotational speed, about the vertical axis of rotation.

### CROSS REFERENCE TO RELATED APPLICATIONS

The present application is a continuation of pending international patent application PCT/EP2004/001256 filed on Feb. 11, 2004 which designates the United States and which claims priority of German patent application 103 06 684.5 filed on Feb. 12, 2003.

### BACKGROUND OF THE INVENTION

The invention relates to an apparatus for treating a particulate material, for example for coating shaped products of a pharmaceutical, food-related, technical or chemical nature.

The invention also relates to a method for operating such an apparatus.

In WO 00/10699, there is described an apparatus for treating a particulate material with a coating medium, in particular for coating shaped products of a pharmaceutical, food-related, technical or chemical nature.

Such an apparatus is used for example in the pharmaceutical, chemical, confectionery or food industry. In the pharmaceutical industry, tablets coated with a sugar syrup known as dragées are produced. Film coating is used to produce coated tablets, understood as meaning forms of administering drugs that are coated with a polymer.

In the known apparatus, the particulate material is introduced into the container and moved by rotation of the container in a continuous circulating motion along the bottom and the upright rotating container wall from a lower region into an upper region of the container, deflected in the upper region of the container by a deflecting element and returned again along an inner returning surface, radially at a distance from the first container wall, to the likewise rotating base of the container.

The deflecting element, which is provided with a plurality of guide vanes, is fixedly connected to the container wall and correspondingly rotates at the same rotational speed as the wall of the container along with it.

A further apparatus of the generic type is known from DE 101 04 184 A1. This differs from the known apparatus described above in that the returning surface for returning the particulate material to the base of the container is arranged outside the upright wall of the container that can be set in rotation. The container of this known apparatus also has in its upper region a deflecting element in order, as a result of rotation of the upright wall, to deflect the material rising up along the wall in its direction of movement in such a way that it can return to the base of the container along the returning surface arranged radially outside. In the case of this known apparatus, the deflecting element is static, i.e. does not rotate along with the particulate material during its circulating motion.

In the case of both known apparatuses mentioned above, the following problems arise in the region of the deflecting element.

If the deflecting element rotates along with the upright wall of the container on which the particulate material rises up on account of the rotation of the wall, with the same rotational speed, the reversal of the movement of the material particles on account of the high centrifugal force acting on the material particles as a result of the rotation of the deflecting element is inadequate, so that the material particles can build up at the deflecting element. In this respect, it must be taken into consideration that the material particles are intended to undergo a reversal of movement of approximately 180° in the region of the deflecting element, but on the other hand have in the upper region of the wall of the container a high kinetic energy and a high momentum in the centrifugal direction with an additional vertically upwardly directed component.

If, on the other hand, as in the case of the other known apparatus mentioned above, the deflecting element is static, the problem of a buildup of particles in the region of the deflecting element does not exist, but the material particles are then greatly exposed to abrasion, which can damage the material particles to be treated, at the transition from the rotating wall of the container to the deflecting element because of the very great difference in speed. Consequently, under some circumstances the result of the treatment of the particulate material, for example the treatment with a coating medium, is not satisfactory.

The problems described above, on the one hand of a buildup of particles in the region of the deflecting element and on the other hand abrasion and damage of the material particles in the region of the deflecting element, occur primarily in the case of those apparatuses which are designed for treating large batches of particulate material. Such apparatuses correspondingly have a container which is made to large dimensions and the upright rotating wall of which correspondingly has a large diameter in the upper region. With increasing diameter of the upper region of the rotating wall, however, the kinetic energy or path speed of the material particles increases, whereby in one case the abrasive forces and in the other case the building-up effect in the region of the deflecting element come to bear especially.

### SUMMARY OF THE INVENTION

The invention is therefore based on the object of developing an apparatus and a method of the type mentioned at the outset so as to achieve on the one hand a uniform circulating motion of the particulate material without compaction of the material at the deflecting element and on the other hand an improved treatment result as a result of a reduction of abrasive forces in the region of the deflecting element.

According to an aspect of the present invention, an apparatus for treating a particulate material is provided, comprising a container, said container having a base, an upright wall extending from said base from bottom to top, and, in an upper region of said container a deflecting element to deflect said material moved up along said wall in direction of movement of said material in such a way that said material can return to said base, wherein it is possible for at least said wall of said container to be driven into rotation about a vertical axis of rotation, and wherein in said upper region of said container there is at least one container element which can be driven in rotation in the same direction as said upright wall, but with lower rotational speed, about said vertical axis of rotation.

According to another aspect of the present invention, a method for operating the afore-mentioned apparatus is provided, comprising the step of setting said at least one container element in rotation with the rotational speed which is less than a rotational speed of said wall.

The container element provided according to the invention makes it possible that the relative speed of the particulate material in relation to the deflecting element can be set in such a way that it is on the one hand lower than in the case of the known apparatus with a static deflecting element, on the other hand higher than in the case of the known apparatus in which the deflecting element rotates along with the rotating wall of the container at the same speed. The container element provided according to the invention absorbs part of the kinetic energy or the momentum of the material particles, in other words slows them down, so that the particulate material is deflected at the deflecting element dependably and without abrasive effects, so that it can return again to the base. The container element may in this case be realized in various ways, as described hereinbelow with respect to preferred embodiments.

The apparatus according to the invention may be provided without a returning surface, with a returning surface arranged inside the wall or a returning surface arranged outside the wall, as is described in the prior art.

In a preferred refinement, the at least one container element is the deflecting element itself.

In this refinement of the apparatus according to the invention, the deflecting element accordingly likewise rotates about the vertical axis of rotation, but with a rotational speed which is lower than the rotational speed of the rotating wall of the container. This measure has the effect that the particulate material has at the deflecting element a relative speed in relation to the latter which is on the one hand low enough to reduce or avoid abrasions of the particulate material, on the other hand great enough to avoid a buildup of the particulate material at the deflecting element, i.e. to dependably ensure that the particulate material is gently and continuously deflected in its direction of movement at the deflecting element, in order that it can return again to the base.

In a further preferred refinement, the at least one container element is at least one wall segment which is adjacent the deflecting element.

In the case of this refinement, there is accordingly between the deflecting element and the wall of the container at least one wall segment which rotates in the same direction as the wall of the container, but with a lower rotational speed than the latter, so that part of the kinetic energy is already extracted from the particulate material at this wall segment before it reaches the deflecting element, whereby the relative speed with respect to the deflecting element can likewise be reduced in such a way that abrasions are reduced or avoided. It is also possible for there to be two or more such wall segments, for example in the case of very large containers.

In a further preferred refinement, both the deflecting element and the at least one wall segment can be driven in rotation about the vertical axis of rotation, it being possible for the rotational speed of the wall segment to be set to a value which is less than the rotational speed of the wall, and it being possible for the rotational speed of the deflecting element to be set to a value which is less than the rotational speed of the wall segment.

In the case of the method for operating the apparatus, it is correspondingly provided that the rotational speed of the wall segment is set to a value which is less than the rotational speed of the wall, and that the rotational speed of the deflecting element is set to a value which is less than the rotational speed of the wall segment.

This refinement has the particular advantage that a multistage lowering of the path speed of the particulate material is achieved in the upper region of the container, leading to a kinematically particularly favorable and at the same time nevertheless gentle deflection of the particulate material at the deflecting element.

In a further preferred refinement of the apparatus, the rotational speed of the at least one container element can be set to a value which lies in the range from approximately 10% to 80%, preferably from approximately 20% to 60%, of the rotational speed of the wall.

In the case of the method, it is correspondingly preferably provided that the at least one container element is set in rotation with a rotational speed which lies in the range from approximately 10% to 80%, preferably from approximately 20% to 60%, of the rotational speed of the wall.

The stated ranges of the relative speeds between the at least one container element and the rotating wall of the container, which may be based on the deflecting element itself and/or the at least one wall segment and/or both the deflecting element and the wall segment, are advantageous with regard to the desired effect of a gentle and kinematically favorable deflection of the material at the deflecting element.

In further preferred refinements of the apparatus, the rotational speed of the at least one container element can be set to such a value that the difference in the path speed between adjacent regions of the wall and of the container element lies in the range from approximately 0.5 to 3 m/s or in the range from approximately 0.9 to 2 m/s.

With regard to the method, it is correspondingly preferred if the rotational speed of the at least one container element is set to such a value that the difference in the path speed between adjacent regions of the wall and of the container element lies in the range from approximately 0.5 to 3 m/s or in the range from approximately 0.9 to 2 m/s.

In these ranges of the difference in path speed of the material particles at the transition from the rotating wall to the container element, for example the rotating deflecting element and/or the at least one wall segment, it has been observed that the abrasive effect and the building-up effect at the deflecting element were reduced to the extent of being eliminated.

In a further preferred refinement of the apparatus, a returning surface that becomes narrower from top to bottom and is intended for returning the material to the base of the container is arranged inside or outside the wall of the container.

As in the case of the known apparatuses, this measure has the advantage that the return of the particulate material from the upper region of the container into the lower region of the container on the one hand takes place at a distance away from the material which is being moved at the time upward along the rotating wall, and on the other hand the material can also flow away on the sloping returning surface in a particularly gentle manner, without hitting the base of the container with high kinetic energy. The returning surface consequently likewise contributes to a gentle movement of the particulate material in the container.

It is preferred in this respect if the returning surface can be driven in rotation about the vertical axis of rotation in the same direction as the wall and with a rotational speed which is equal to or less than the rotational speed of the at least one container element, in particular if the latter is the deflecting element itself.

When the deflecting element has been set in rotation, the rotational movement of the deflecting element imparts to the particulate material a centrifugally tangential movement component, which is then taken up by the co-rotation of the returning surface, so that the particulate material arrives on the returning surface with a low relative speed, whereby abrasions of the particulate material are avoided even in the region of the transition from the deflecting element to the returning surface. As already described above in connection with the wall segment of the container, the returning surface may also have one or more wall segments which are adjacent the deflecting element, and which then rotate with a rotational speed decreasing from top to bottom, it then being possible for example for the lower part of the returning surface to be static.

In a further preferred refinement of the apparatus, a drive which drives the container element independently of the wall is provided for the at least one container element.

Here it is of advantage that the rotational speed of the at least one container element can be set by means of a corresponding control apparatus independently of the rotational speed of the wall of the container, which also makes it possible in particular for the rotational speed of the at least one container element to be adapted in accordance with the nature of the material to be treated.

However, it may also be provided that a drive which transfers the rotational movement of the wall into a slower rotational movement of the at least one container element is provided for the at least one container element.

Such a conversion may take place for example by means of a gear mechanism, multistep gear mechanisms being of advantage for setting different relative speeds between the at least one container element and the wall of the container, in order to be able to set different rotational speeds of the at least one container element.

Further advantages and features emerge from the following description and the accompanying drawing.

It goes without saying that the features mentioned above and still to be explained below can be used not only in the respectively specified combination, but also in other combinations or on their own, without departing from the scope of the present invention.

### BRIEF DESCRIPTION OF THE DRAWINGS

An exemplary embodiment of the invention is represented in the drawing and is described in more detail below with reference to said drawing, in which:

FIG. 1 shows a portion in cross section of an apparatus for treating a particulate material in a first operating position;

FIG. 2 shows the apparatus in FIG. 1 in a second operating position;

FIG. 3 shows a partial representation of the apparatus in FIG. 1 on an enlarged scale.

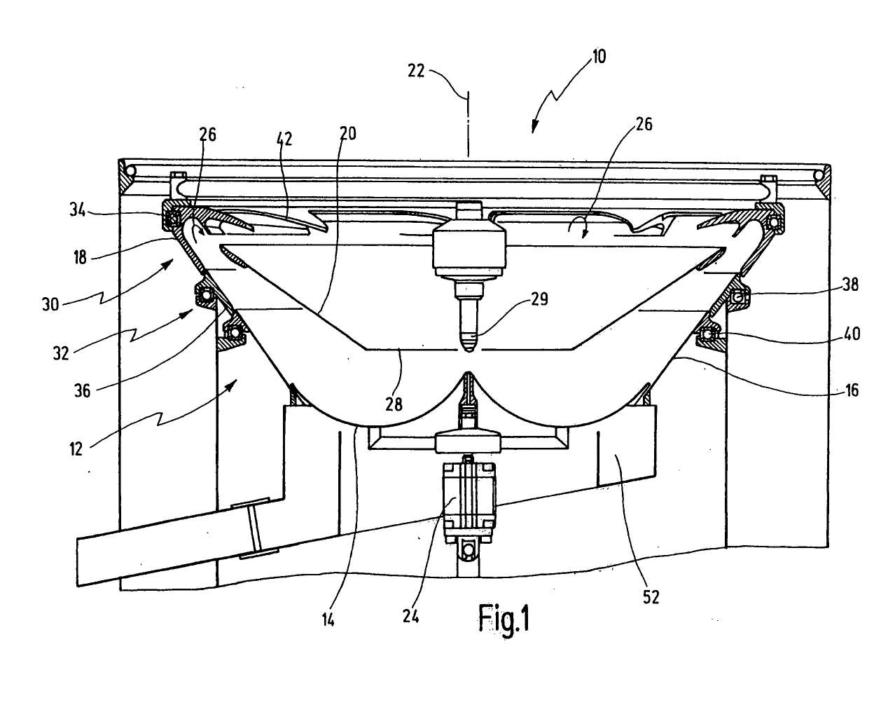

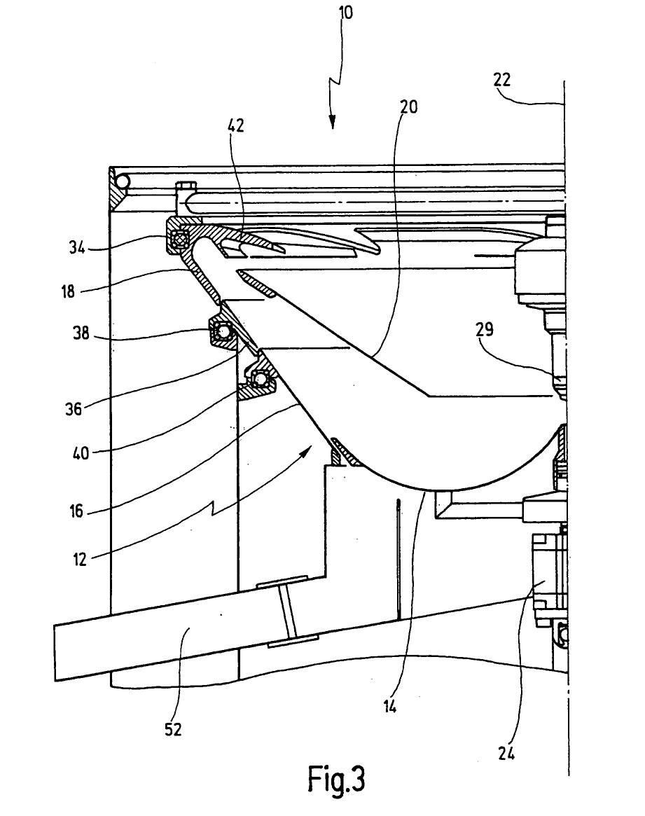

In FIGS. 1 to 3, a detail of an apparatus for treating a particulate material is represented, provided generally with the reference numeral 10. With the apparatus 10, particulate material can be treated, for example with a coating medium, and the apparatus 10 may be used in particular for the film coating, including drying, of shaped products of a pharmaceutical, food-related or technical nature. With respect to the implementation of a method for treating the particulate material with the apparatus 10, reference is made to the published international patent application with the publication number WO 00/10699.

### DETAILED DESCRIPTION OF A PREFERRED EMBODIMENT

The apparatus 10 has a container 12, which has a base 14, an upright wall 16, a deflecting element 18 and a returning surface 20 inside the wall 16.

The double-curved base 14 and the upright wall 16, taking the form of the lateral area of a cone, can be driven in rotation about a vertical axis of rotation 22. The base 14 is in this case rotatable with the same or a different rotational speed with respect to the upright wall 16.

A multishaft rotary drive 24 serves the purpose of setting the base 14 and the wall 16 in rotation with different rotational speeds, preferably in the same direction of rotation.

In the operation of the apparatus 10, the particulate material is introduced into the container 12. The rotation of the base 14 and the wall 16 of the container 12 have the effect that, on account of centrifugal forces, the particulate material moves along the base 14 and then along the wall 16 into the upper region of the container 12, is deflected there in its direction of movement according to an arrow 26 and then passes from the deflecting element 18 onto the returning surface 20, on which it slides down under the effect of gravity and falls back onto the base 14 out of a lower opening 28 in the returning surface 20, which has overall the form of a cone. Depending on the treatment carried out, during the falling back from the returning surface 20 onto the base 14, the particulate material is sprayed with a coating medium which is discharged from a nozzle 29.

To this extent, the apparatus 10 corresponds to the apparatus known from WO 00/10699.

As a difference from the known apparatus, in the upper region of the container 12 of the apparatus 10 there is at least one container element, and in the present exemplary embodiment there are in the upper region of the container 12 two container elements 30 and 32, to lower the path speed of the material particles, or obtain a specific relative speed of the material particles in relation to the deflecting element 18, in that the container elements 30 and 32 can be driven in rotation about the vertical axis of rotation 22 in the same direction of rotation as the upright wall 16, but with a lower rotational speed.

The first container element 30 is the deflecting element 18 itself. In a corresponding way, the deflecting element 18 can be driven in rotation about the vertical axis of rotation 22, to be precise in the same direction as the wall 16, but with a lower rotational speed. The deflecting element 18 is correspondingly mounted by means of a rotary bearing 34, for example a thin ring bearing.

The second container element 32 is a wall segment 36, which is adjacent the deflecting element 18. Like the wall 16, the wall segment 36 takes the form of the lateral area of a truncated cone and is mounted rotatably about the vertical axis of rotation 22 by means of a rotary bearing 38. The wall 16 is for its part mounted rotatably about the vertical axis of rotation 22 by means of a further rotary bearing 40. The rotary bearings 38 and 40 take the form for example of thin ring bearings.

The rotational speed of the wall segment 36 can be set to a value which is less than the rotational speed of the wall 16, and the rotational speed of the deflecting element 18 can be set to a value which is less than the rotational speed of the wall segment 36. In this way, the circumferential or path speed of the particulate material which passes from the rotating wall 16 to the wall segment and subsequently to the deflecting element 18 is gradually reduced, whereby a specific relative speed between the material particles and the deflecting element 18 is obtained, avoiding or at least reducing the abrasions, and nevertheless ensuring a continuous, dependable deflection and transfer of the material particles from the deflecting element 18 to the returning surface 20 without a particle buildup occurring at the deflecting element 18.

The wall segment 36 and the deflecting element 18 are provided with corresponding drives, which make it possible to set their rotational speed independently of one another and independently of the rotational speed of the wall 16. For example, the drive 24 provided for the base 14 and the wall 16 may have further drive shafts, the rotation of which is then transferred to the container elements 30 and 32.

The rotational speed of the container elements 30 and 32 can be set to a value which lies in the range from approximately 10% to 80% of the rotational speed of the wall 16, this applying in particular to the rotational speed of the deflecting element 18. Given a value of a rotational speed of the deflecting element 18 of from 20 to 50% of the rotational speed of the wall 16, good results can be achieved.

The rotational speed of the deflecting element 18 can be set to such a value that the difference in the path speed between adjacent regions of the deflecting element 18 and of the wall segment 36 lies in the range from approximately 0.5 to 3 m/s, in particular from approximately 0.9 to 2 m/s.

In the case of containers 12 of a particularly large volume for treating large batches of a particulate material, the wall segment 36 of the container 12 that is rotatable with a lower rotational speed brings about a lowering of the path speed of the material particles to an intermediate range, so that the transition from the rotational speed of the wall 16 to the rotational speed of the deflecting element 18 is moderated. It is also possible for a number of wall segments of this type axially following directly one after the other to be provided, bringing about a multistage lowering of the speed of the material particles.

The deflecting element 18 is provided with a number of guide vanes 42, which may be formed with rearward curvatures with respect to the direction of rotation, the guide vanes 42 only protruding slightly into the upper diameter of the returning surface 20, while the upper end of the returning surface 20 extends almost up to the diameter of the deflecting element 18.

The apparatus 10 is therefore operated in such a way that, with the wall 16 rotating, the wall segment 36 is set in rotation with a rotational speed which is less than the rotational speed of the wall 16. The deflecting element 18 is likewise set in rotation in the same direction as the wall segment 36 and the wall 16, but with a still lower rotational speed than the wall segment 36, so that the rotational speeds are stepped down from the wall 16 via the wall segment 36 to the deflecting element 18.

It goes without saying that in other refinements of the apparatus 10 the wall segment 36 may be omitted or fixedly connected to the wall 16 of the container 12, then only the deflecting element 18 being able to be set in rotation with a lower rotational speed in relation to the wall 16, or the deflecting element 18 is static, i.e. cannot be set in rotation, then one or more wall segments like the wall segment 36 being present, bringing about a lowering of the path speed of the material particles, so that the relative speed between the material particles and the then static deflecting element 18 lies in a range in which abrasion is avoided or reduced and a kinematically favorable deflection of the material particles from the wall 16 via the deflecting element 18 to the returning surface 20 is ensured.

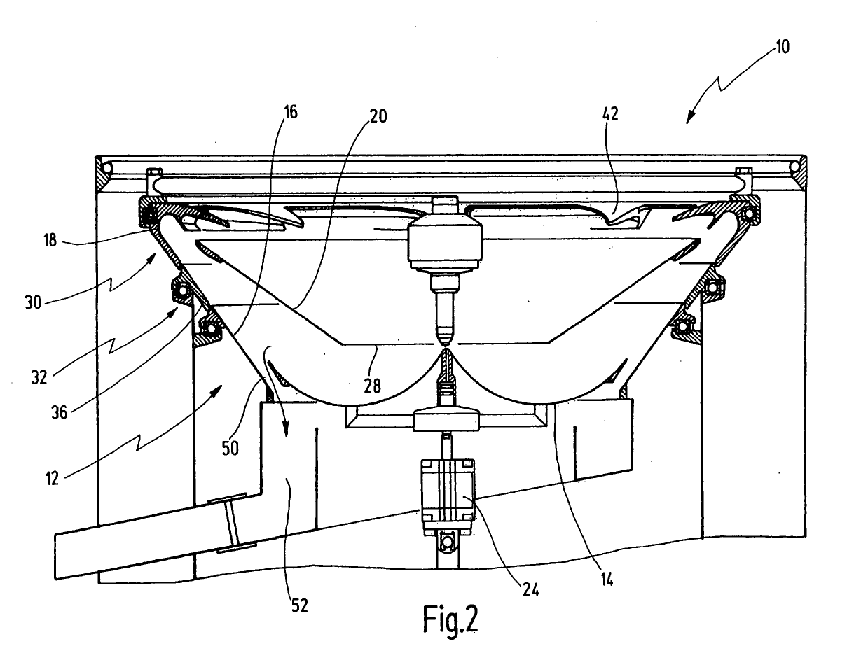

In FIG. 1, the apparatus 10 is represented in an operating position in which the particulate material is treated in the container 12 in continuous circulation. In FIG. 2, the apparatus 10 is represented in an operating position in which the particulate material is emptied out of the container 12 after completion of the treatment. For this purpose, the base 14 is raised with respect to the wall 16, so that the particulate material can flow away through a gap 50 between the base 14 and the wall 16 out of the container 12 into an emptying channel 52 and via the latter out of the apparatus 10. Part of the material which is still lying on the base 14 can be removed from the base 14 by rotation of the base with the wall 16 stationary, and then likewise passes into the gap 50 and into the emptying channel 52 for the complete discharge of the material from the container 12.

What is claimed is:

1. An apparatus for treating a particulate material, comprising a container, said container having a base, an upright wall extending from said base from bottom to top, and, in an upper region of said container a deflecting element to deflect said material moved up along said wall in direction of movement of said material in such a way that said material can return to said base,
wherein it is possible for at least said wall of said container to be driven into rotation about a vertical axis of rotation,
and wherein in said upper region of said container there is at least one container element which can be driven in rotation in the same direction as said upright wall, but with lower rotational speed, about said vertical axis of rotation.

2. The apparatus of claim 1, wherein said at least one container element is said deflecting element itself.

3. The apparatus of claim 1, wherein said at least one container element is at least one wall segment which is adjacent said deflecting element.

4. The apparatus of claim 3, wherein both said deflecting element and said at least one wall segment can be driven in rotation about said vertical axis of rotation, it being possible for a rotational speed of said wall segment to be set to a value which is less than a rotational speed of said wall, and it being possible for said rotational speed of said deflecting element to be set to a value which is less than said rotational speed of said wall segment.

5. The apparatus of claim 1, wherein a rotational speed of said at least one container element can be set to a value which lies in the range from about approximately 10% to 80% of a rotational speed of said wall.

6. The apparatus of claim 1, wherein a rotational speed of said at least one container element can be set to a value which lies in the range from approximately 20% to 60% of a rotational speed of said wall.

7. The apparatus of claim 1, wherein a rotational speed of said at least one container element can be set to such a value that a difference in a path speed between adjacent regions of said wall and of said container element lies in the range from approximately 0.5 to 3 m/s.

8. The apparatus of claim 1, wherein a rotational speed of said at least one container element can be set to such a value that a difference in a path speed between adjacent regions of said wall and of said container element lies in the range from approximately 0.9 to 2 m/s.

9. The apparatus of claim 1, wherein a returning surface that becomes narrower from top to bottom and is intended for returning said material to said base of said container is provided.

10. The apparatus of claim 9, wherein said returning surface can be driven in rotation about said vertical axis of rotation in the same direction as said wall and with a rotational speed which is equal to or less than a rotational speed of said at least one container element.

11. The apparatus of claim 1, wherein a drive which drives said container element independently of said wall is provided for said at least one container element.

12. The apparatus of claim 1, wherein a drive which transfers a rotational movement of said wall into a slower rotational movement of said at least one container element is provided for said at least one container element.

13. A method for operating an apparatus for treating a particulate material, said apparatus comprising a container, said container having a base, an upright wall extending from said base from bottom to top, and, in an upper region of said container a deflecting element to deflect said material moved up along said wall in direction of movement of said material in such a way that said material can return to said base, wherein it is possible for at least said wall of said container to be driven into rotation about a vertical axis of rotation, and wherein in said upper region of said container there is at least one container element which can be driven in rotation in the same direction as said upright wall, but with lower rotational speed, about said vertical axis of rotation,
said method for operating comprising the step of setting said at least one container element in rotation with the rotational speed which is less than a rotational speed of said wall.

14. The method of claim 13, wherein both said deflecting element and at least one wall segment can be driven in rotation about said vertical axis of rotation, the method further comprising setting a rotational speed of said segment to a value which is less than a rotational speed of said wall, and setting a rotational speed of said deflecting element to a value which is less than said rotational speed of said wall segment.

15. The method of claim 13, further comprising setting said at least one container element in rotation with a rotational speed which lies in the range from approximately 10% to 80% of a rotational speed of said wall.

16. The method of claim 13, further comprising setting said at least one container element in rotation with a rotational speed which lies in the range from approximately 10% to 60% of a rotational speed of said wall.

17. The method of claim 13, further comprising setting a rotational speed of said at least one container element to such a value that a difference in a path speed between adjacent regions of said wall and of said container element lies in the range from approximately 0.5 to 3 m/s.

18. The method of claim 13, further comprising setting a rotational speed of said at least one container element to such a value that a difference in a path speed between adjacent regions of said wall and of said container element lies in the range from approximately 0.9 to 2 m/s.
